(19) United States
(12) Patent Application Publication
(10) Pub. No.: US 2020/0309995 A1
(43) Pub. Date: Oct. 1, 2020

(54) ANTI-REFLECTIVE COATINGS FOR TRANSPARENT ELECTROACTIVE TRANSDUCERS

(71) Applicant: Facebook Technologies, LLC, Menlo Park, CA (US)

(72) Inventors: Spencer Allan Wells, Seattle, WA (US); Katherine Marie Smyth, Seattle, WA (US); Andrew John Ouderkirk, Redmond, WA (US)

(21) Appl. No.: 16/364,228

(22) Filed: Mar. 26, 2019

(51) Int. Cl. G02B 1/111; G02B 1/116; G02B 3/12; G02B 27/01

(52) U.S. Cl. CPC G02B 1/111; G02B 1/116; G02B 2027/0178; G02B 27/0172; G02B 3/12

(57) ABSTRACT

An anti-reflective coating may include an optically transparent electrically conductive layer disposed over a substrate, and a dielectric layer disposed over the electrically conductive layer. The substrate may include an electroactive material. An optical element may include such an anti-reflective coating, where a primary anti-reflective coating may be disposed over a first surface of the electroactive layer and a secondary anti-reflective coating may be disposed over a second surface of the electroactive layer opposite the first surface.

### BACKGROUND

Polymeric and other dielectric materials may be incorporated into a variety of optic and electro-optic device architectures, including active and passive optics and electroactive devices. Electroactive materials, including electroactive polymer (EAP) materials, for instance, may change their shape under the influence of an electric field. EAP materials have been investigated for use in various technologies, including actuation, sensing and/or energy harvesting. Lightweight and conformable, electroactive polymers may be incorporated into wearable devices such as haptic devices and are attractive candidates for emerging technologies including virtual reality/augmented reality devices where a comfortable, adjustable form factor is desired.

Virtual reality and augmented reality eyewear devices or headsets may enable users to experience events, such as interactions with people in a computer-generated simulation of a three-dimensional world or viewing data superimposed on a real-world view. Virtual reality/augmented reality eyewear devices and headsets may also be used for purposes other than recreation. For example, governments may use such devices for military training, medical professionals may use such devices to simulate surgery, and engineers may use such devices as design visualization aids.

These and other applications may leverage one or more characteristics of thin film electroactive materials, including the Poisson's ratio to generate a lateral deformation (e.g., lateral expansion or contraction) as a response to compression between conductive electrodes. Example virtual reality/augmented reality assemblies containing electroactive layers may include deformable optics, such as mirrors, lenses, or adaptive optics. Deformation of the electroactive polymer may be used to actuate optical elements in an optical assembly, such as a lens system.

Although thin layers of many electroactive polymers and piezoceramics can be intrinsically transparent, in connection with their incorporation into an optical assembly or optical device, a variation in refractive index between such materials and adjacent layers, such as air, may cause light scattering and a corresponding degradation of optical quality or performance. Thus, notwithstanding recent developments, it would be advantageous to provide polymeric or other dielectric materials having improved actuation characteristics, including a controllable and robust deformation response in an optically transparent package.

### SUMMARY

As will be described in greater detail below, the instant disclosure relates to actuatable and transparent optical elements and methods for forming such optical elements. The optical elements may include an anti-reflective coating that improves the optical clarity of the optical element while exhibiting mechanical stability, e.g., strain and/or fatigue tolerance, over multiple actuation cycles.

An optical element may include a layer of electroactive material sandwiched between conductive electrodes. The electroactive layer may include a polymer or ceramic material, for example, whereas the electrodes may each include one or more layers of any suitable conductive material(s), such as transparent conductive oxides (e.g., TCOs such as ITO), graphene, etc. In accordance with various embodiments, the optical transmissivity of an optical element may be improved by incorporating an anti-reflective coating (ARC) into the optical element geometry. For instance, layers of an anti-reflective coating may be disposed over either or both electrodes and may include one or more material layers used to decrease the gradient in refractive index between the electrode and an adjacent medium.

The electrodes, which may constitute a portion of the ARC coating, may be used to affect large scale deformation, i.e., via full-area coverage, or the electrodes may be patterned to provide spatially localized stress/strain profiles. In particular embodiments, a deformable optical element and an electroactive layer may be co-integrated whereby the deformable optic may itself be actuatable. In addition, various methods of forming optical elements are disclosed, including solution-based and solid-state deposition techniques.

In accordance with certain embodiments, an optical element including an electroactive layer disposed between transparent electrodes and also including an anti-reflective coating (ARC) may be incorporated into a variety of device architectures where capacitive actuation and the attendant strain realized in the electroactive layer (i.e., lateral expansion and compression in the direction of the applied electric field) may induce deformation in one or more adjacent active layers within the device and accordingly change the optical performance of the active layer(s). Lateral deformation may be essentially 1-dimensional, in the case of an anchored thin film, or 2-dimensional. In some embodiments, the engineered deformation of two or more electroactive layers that are alternatively placed in expansion and compression by oppositely applied voltages may be used to induce bending or curvature changes in a device stack, which may be used to provide optical tuning such as focus or aberration control.

According to various embodiments, an optical element may include an anti-reflective coating disposed over a substrate. The anti-reflective coating may include an optically transparent and electrically conductive layer, i.e., an electrode, and a dielectric layer disposed over the electrically conductive layer. As will be appreciated, the substrate may include an electroactive material.

The anti-reflective coating may be optically transparent and accordingly exhibit less than 10% haze and a transmissivity within the visible spectrum of at least 50%. For instance, the anti-reflective coating may be configured to maintain at least 50% transmissivity over 10⁶ actuation cycles and an induced engineering strain of up to approximately 1%. In some embodiments, the anti-reflective coating may exhibit a reflectivity within the visible spectrum of less than approximately 3%.

In some embodiments, the electrically conductive layer, i.e., an electrode, may be disposed over a portion of the substrate and may include a material such as a transparent conducting oxide (e.g., ITO), graphene, nanowires, or carbon nanotubes. A refractive index of the electrically conductive layer may be constant or may vary along at least one dimension thereof, e.g., the refractive index of the electrically conductive layer may vary as a function of its thickness. In some embodiments, an electrically conductive mesh may be disposed adjacent to the electrically conductive layer. The electrically conductive mesh may be less transparent than the electrically conductive layer but have an electrical conductivity greater than the electrically conductive layer.

The dielectric layer may include any suitable dielectric material(s), including silicon dioxide, zinc oxide, aluminum oxide, and/or magnesium fluoride, although additional dielectric materials are contemplated. In some embodiments, the dielectric layer may be configured as a multi-layer stack. By way of example, a multi-layer stack may include a layer of zinc oxide disposed directly over the electrically conductive layer and a layer of silicon dioxide disposed over the layer of zinc oxide. Additional layers may be used, such as in an architecture that includes alternating layers of a first dielectric material and a second dielectric material. Independent of the number of dielectric layers, according to some embodiments, a refractive index of the dielectric layer may be less than a refractive index of the electrically conductive layer, which, in turn, may be less than a refractive index of the substrate.

Also disclosed is an optical element that may include a transparent electroactive layer, a primary anti-reflective coating disposed over a first surface of the electroactive layer, and a secondary anti-reflective coating disposed over a second surface of the electroactive layer opposite the first surface. The primary anti-reflective coating may include a primary conductive layer disposed directly over the first surface of the electroactive layer and a primary dielectric layer disposed over the primary conductive layer, while the secondary anti-reflective coating may include a secondary conductive layer disposed directly over the second surface of the electroactive layer and a secondary dielectric layer disposed over the secondary conductive layer.

In some embodiments, the electroactive layer may include a piezoelectric polymer, an electrostrictive polymer, a piezoelectric ceramic, or an electrostrictive ceramic. The electroactive layer may include a polymer layer, such as a dielectric elastomer. Example polymer materials include a PVDF homopolymer, a P(VDF-TrFE) co-polymer, a P(VDF-TrFE-CFE) ter-polymer, or a P(VDF-TrFE-CTFE) ter-polymer. In further embodiments, the electroactive layer may include a ceramic layer, such as a piezoelectric ceramic, an electrostrictive ceramic, a polycrystalline ceramic, or a single crystal ceramic. Example electroactive ceramics may include one or more ferroelectric ceramics, such as perovskite ceramics.

In example optical elements, each of the primary anti-reflective coating and the secondary anti-reflective coating may be configured to maintain at least 50% transmissivity therethrough over 10⁶ actuation cycles and an accompanying engineering strain of up to approximately 1%. An optical element may further include a liquid lens or other optical element disposed over one of the primary dielectric layer and the secondary dielectric layer and may, in certain embodiments, be incorporated into a head-mounted display.

According to further embodiments, a method may include forming an electrically conductive layer over an electroactive substrate and forming a dielectric layer over the electrically conductive layer to form an optical element, where the optical element exhibits less than 10% haze and a transmissivity within the visible spectrum of at least 50%. In various methods, the electrically conductive layer and the dielectric layer may be formed sequentially or simultaneously, such as by co-extrusion.

In certain embodiments, an electroactive layer may be pre-stressed and thus exhibit a non-zero stress state when zero voltage is applied between the primary electrode and the secondary electrode.

Many electroactive materials, including various electroactive ceramics, have a relatively large refractive index (e.g., n>2). As will be appreciated, in optical devices including electroactive materials, a refractive index mismatch, i.e., a discontinuous change in the refractive index between such materials and air (n=1), for example, may create undesirable reflective losses.

In accordance with some embodiments, an anti-reflective coating may operate to gradually decrease the refractive index between that of the electroactive layer and an adjacent, typically lower index material. In various embodiments, an anti-reflective coating may include multiple layers of varying refractive index and/or one or more layers having a refractive index gradient. In some embodiments, an optically transparent electrically conductive layer, i.e., an electrode, may be incorporated into the anti-reflective coating.

In optical elements having a multi-layer architecture, an optical element may include a tertiary electrode overlapping at least a portion of the secondary electrode, and a second electroactive layer disposed between and abutting the secondary electrode and the tertiary electrode. In an example device, one of the first electroactive layer and the second electroactive layer may be in a state of lateral compression while the other of the first electroactive layer and the second electroactive layer may be in a state of lateral expansion.

Features from any of these or other embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an anti-reflective coating including a dielectric layer disposed over an electrically conductive layer according to some embodiments.

FIG. 2 shows an anti-reflective coating having a pair of dielectric layers disposed over an electrically conductive layer according to some embodiments.

FIG. 3 shows an anti-reflective coating having a dielectric layer disposed over a pair of electrically conductive layers according to some embodiments.

FIG. 4 depicts an anti-reflective coating configured as a multi-layer stack according to certain embodiments.

FIG. 5 depicts an anti-reflective coating configured as a multi-layer stack according to further embodiments.

FIG. 6 is an illustration of an anti-reflective coating including a graded index dielectric layer disposed over an electrically conductive layer according to some embodiments.

FIG. 7 is an illustration of an anti-reflective coating including a dielectric layer having a textured surface disposed over an electrically conductive layer according to certain embodiments.

FIG. 8 shows an optical element having an anti-reflective coating disposed over opposing surfaces according to some embodiments.

FIG. 9 is a schematic illustration of an example head-mounted display according to various embodiments.

FIG. 10 is an illustration of an exemplary artificial-reality headband that may be used in connection with embodiments of this disclosure.

FIG. 11 is an illustration of exemplary augmented-reality glasses that may be used in connection with embodiments of this disclosure.

FIG. 12 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to optical elements, and more particularly to optical elements that include an electroactive layer with an anti-reflective coating (ARC) formed over at least one surface thereof. The electroactive layer may be capacitively actuated to deform an optical element and hence modify its optical performance. By way of example, the optical element may be located within the transparent aperture of an optical device such as a liquid lens, although the present disclosure is not particularly limited and may be applied in a broader context. By way of example, the optical element may be incorporated into an active grating, tunable lens, accommodative optical elements, or adaptive optics and the like. According to various embodiments, the optical element may be optically transparent.

As used herein, a material or element that is “transparent” or “optically transparent” may, for example, have a transmissivity within the visible light spectrum of at least approximately 50%, e.g., approximately 50, 60, 70, 80, 90, 95, 97, 98, 99, or 99.5%, including ranges between any of the foregoing values, and less than approximately 80% haze, e.g., approximately 1, 2, 5, 10, 20, 30, 40, 50, 60 or 70% haze, including ranges between any of the foregoing values. In accordance with some embodiments, a “fully transparent” material or element may have a transmissivity (i.e., optical transmittance) within the visible light spectrum of at least approximately 80%, e.g., approximately 80, 90, 95, 97, 98, 99, or 99.5%, including ranges between any of the foregoing values, and less than approximately 10% haze, e.g., approximately 0, 1, 2, 4, 6, or 8% haze, including ranges between any of the foregoing values.

In accordance with various embodiments, an optical element may include a primary electrode, a secondary electrode overlapping at least a portion of the primary electrode, and an electroactive layer disposed between and abutting the primary electrode and the secondary electrode, where the optical element is at least partially optically transparent. One or more additional dielectric layers forming an anti-reflective coating may be disposed over either or both surfaces of the electroactive layer. The electroactive layer may include one or more electroactive materials.

### Electroactive Materials

An optical element may include one or more electroactive materials, such as electroactive polymers or ceramics and may also include additional components. As used herein, “electroactive materials” may, in some examples, refer to materials that exhibit a change in size or shape when stimulated by an electric field. In some embodiments, an electroactive material may include a deformable polymer or ceramic that may be symmetric with regard to electrical charge (e.g., polydimethylsiloxane (PDMS), acrylates, etc.) or asymmetric (e.g., poled polyvinylidene fluoride (PVDF) or its copolymers such as poly(vinylidenefluoride-co-trifluoroethylene) (PVDF-TrFE)). Further PVDF-based polymers may include poly(vinylidene fluoride-trifluoroethylene-chlorofluoroethylene (P(VDF-TrFE-CFE)) or poly(vinylidenefluoride-trifluoroethylene-chlorotrifluoroethylene (P(VDF-TrFE-CTFE)).

For piezoelectric polymers like PVDF homopolymer, the piezoelectric response may be tuned by altering the crystalline content and the crystalline orientation within the polymer matrix, e.g., by uniaxial or biaxial stretching, optionally followed by poling. The origin of piezoelectricity in PVDF homopolymer is believed to be the β-phase crystallite polymorph, which is the most electrically active and polar of the PVDF phases. Alignment of the β-phase structure may be used to achieve the desired piezoelectric effect. Poling may be performed to align the β-phase and enhance the piezoelectric response. Other piezoelectric polymers, such as PVDF-TrFE and PVDF-TrFE-CFE may be suitably oriented upon formation and the piezoelectric response of such polymers may be improved by poling with or without stretching.

Additional examples of materials forming electroactive polymers may include, without limitation, styrenes, polyesters, polycarbonates, epoxies, halogenated polymers, such as PVDF, copolymers of PVDF, such as PVDF-TrFE, silicone polymers, and/or any other suitable polymer or polymer precursor materials including ethyl acetate, butyl acrylate, octyl acrylate, ethylethoxy ethyl acrylate, 2-chloroethyl vinyl ether, chloromethyl acrylate, methacrylic acid, dimethacrylate oligomers, isocyanates, allyl glycidyl ether, N-methylol acrylamide, or mixtures thereof. Example acrylates may be free-radical initiated. Such materials may have any suitable dielectric constant or relative permittivity, such as, for example, a dielectric constant ranging from approximately 2 to approximately 30.

In the presence of an electrostatic field (E-field), an electroactive material may deform (e.g., compress, elongate, bend, etc.) according to the magnitude and direction of the applied field. Generation of such a field may be accomplished, for example, by placing the electroactive material between two electrodes, i.e., a primary electrode and a secondary electrode, each of which is at a different potential. As the potential difference (i.e., voltage difference) between the electrodes is increased (e.g., from zero potential) the amount of deformation may also increase, principally along electric field lines. This deformation may achieve saturation when a certain electrostatic field strength has been reached. With no electrostatic field, the electroactive material may be in its relaxed state undergoing no induced deformation, or stated equivalently, no induced strain, either internal or external.

In some instances, the physical origin of the compressive nature of electroactive materials in the presence of an electrostatic field (E-field), being the force created between opposite electric charges, is that of the Maxwell stress, which is expressed mathematically with the Maxwell stress tensor. The level of strain or deformation induced by a given E-field is dependent on the square of the E-field strength, as well as the dielectric constant and elastic compliance of the electroactive material. Compliance in this case is the change of strain with respect to stress or, equivalently, in more practical terms, the change in displacement with respect to force. In some embodiments, an electroactive layer may be pre-strained (or pre-stressed) to modify the stiffness of the optical element and hence its actuation characteristics.

In some embodiments, an electroactive polymer may include an elastomer. As used herein, an “elastomer” may, in some examples, refer to a material having viscoelasticity (i.e., both viscosity and elasticity), relatively weak intermolecular forces, and generally low elastic modulus (a measure of the stiffness of a solid material) and a high strain-to-failure compared with other materials. In some embodiments, an electroactive polymer may include an elastomer material that has an effective Poisson's ratio of less than approximately 0.35 (e.g., less than approximately 0.3, less than approximately 0.25, less than approximately 0.2, less than approximately 0.15, less than approximately 0.1, or less than approximately 0.05). In at least one example, the elastomer material may have an effective density that is less than approximately 90% (e.g., less than approximately 80%, less than approximately 70%, less than approximately 60%, less than approximately 50%, less than approximately 40%) of the elastomer when densified (e.g., when the elastomer is compressed, for example, by electrodes to make the elastomer more dense).

In some embodiments, the term “effective density,” as used herein, may refer to a parameter that may be obtained using a test method where a uniformly thick layer of an electroactive ceramic or polymer, e.g., elastomer, may be placed between two flat and rigid circular plates. In some embodiments, the diameter of the electroactive material being compressed may be at least 100 times the thickness of the electroactive material. The diameter of the electroactive layer may be measured, then the plates may be pressed together to exert a pressure of at least approximately 1x10⁶ Pa on the electroactive layer, and the diameter of the layer is remeasured. The effective density may be determined from an expression (DR =Duncompressed I Dcompressed), where DR may represent the effective density ratio, Duncompressed may represent the density of the uncompressed electroactive layer, and Dcomₚressed may represent the density of the compressed electroactive layer.

In some embodiments, the optical elements described herein may include an elastomeric electroactive polymer having an effective Poisson's ratio of less than approximately 0.35 and an effective uncompressed density that is less than approximately 90% of the elastomer when densified. In some embodiments, the term “effective Poisson's ratio” may refer to the negative of the ratio of transverse strain (e.g., strain in a first direction) to axial strain (e.g., strain in a second direction) in a material.

### Electrodes

In some embodiments, optical elements may include paired electrodes, which allow the creation of the electrostatic field that forces constriction of the electroactive layer. In some embodiments, an “electrode,” as used herein, may refer to an electrically conductive material, which may be in the form of a thin film or a layer. Electrodes may include relatively thin, electrically conductive metals or metal alloys and may be of a non-compliant or compliant nature.

In some embodiments, the electrodes may include a metal such as aluminum, gold, silver, tin, copper, indium, gallium, zinc, alloys thereof, and the like. An electrode may include one or more electrically conductive materials, such as a metal, a semiconductor (such as a doped semiconductor), carbon nanotubes, graphene, carbon black, transparent conductive oxides (TCOs, e.g., indium tin oxide (ITO), zinc oxide (ZnO), etc.), or other electrically conducting material. Further example transparent conductive oxides include, without limitation, aluminum-doped zinc oxide, fluorine-doped tin oxide, indium-doped cadmium oxide, indium zinc oxide, indium gallium tin oxide, indium gallium zinc tin oxide, and indium zinc tin oxide.

In some embodiments, the electrode or electrode layer may be self-healing, such that damage from local shorting of a circuit can be isolated. Suitable self-healing electrodes may include thin films of materials which deform or oxidize irreversibly upon Joule heating, such as, for example, graphene.

In some embodiments, a primary electrode may overlap (e.g., overlap in a parallel direction) at least a portion of a secondary electrode. The primary and secondary electrodes may be generally parallel and spaced apart and separated by a layer of electroactive material. A tertiary electrode may overlap at least a portion of either the primary or secondary electrode.

An optical element may include a first electroactive layer (e.g., elastomer material) which may be disposed between a first pair of electrodes (e.g., the primary electrode and the secondary electrode). A second optical element, if used, may include a second electroactive layer and may be disposed between a second pair of electrodes. In some embodiments, there may be an electrode that is common to both the first pair of electrodes and the second pair of electrodes.

In some embodiments, one or more electrodes may be optionally electrically interconnected, e.g., through a contact layer, to a common electrode. In some embodiments, an optical element may have a first common electrode, connected to a first plurality of electrodes, and a second common electrode, connected to a second plurality of electrodes. In some embodiments, electrodes (e.g., one of a first plurality of electrodes and one of a second plurality of electrodes) may be electrically isolated from each other using an insulator, such as a dielectric layer. An insulator may include a material without appreciable electrical conductivity, and may include a dielectric material, such as, for example, an acrylate or silicone polymer.

In some embodiments, a common electrode may be electrically coupled (e.g., electrically contacted at an interface having a low contact resistance) to one or more other electrode(s), e.g., a secondary electrode and a tertiary electrode located on either side of a primary electrode.

In some embodiments, electrodes may be flexible and/or resilient and may stretch, for example elastically, when an optical element undergoes deformation. In this regard, electrodes may include one or more transparent conducting oxides (TCOs) such as indium oxide, tin oxide, indium tin oxide (ITO) and the like, graphene, carbon nanotubes, etc. In other embodiments, relatively rigid electrodes (e.g., electrodes including a metal such as aluminum) may be used.

In some embodiments, the electrodes (e.g., the primary electrode and the secondary electrode) may have a thickness of approximately 0.35 nm to approximately 1000 nm, e.g., approximately 0.35, 0.5, 1, 2, 5, 10, 20, 50, 100, 200, 500, or 1000 nm, including ranges between any of the foregoing values, with an example thickness of approximately 10 nm to approximately 50 nm. In some embodiments, a common electrode may have a sloped shape, or may be a more complex shape (e.g., patterned or freeform). In some embodiments, a common electrode may be shaped to allow compression and expansion of an optical element or device during operation.

The electrodes in certain embodiments may have an optical transmissivity of at least approximately 50%, e.g., approximately 50%, approximately 60%, approximately 70%, approximately 80%, approximately 90%, approximately 95%, approximately 97%, approximately 98%, approximately 99%, or approximately 99.5%, including ranges between any of the foregoing values.

In some embodiments, the electrodes described herein (e.g., the primary electrode, the secondary electrode, or any other electrode including any common electrode) may be fabricated using any suitable process. For example, the electrodes may be fabricated using physical vapor deposition (PVD), chemical vapor deposition (CVD), atomic layer deposition (ALD), evaporation, spray-coating, spin-coating, dip-coating, screen printing, Gravure printing, ink jet printing, aerosol jet printing, doctor blading, and the like. In further aspects, the electrodes may be manufactured using a thermal evaporator, a sputtering system, stamping, and the like.

In some embodiments, a layer of electroactive material may be deposited directly on to an electrode. In some embodiments, an electrode may be deposited directly on to the electroactive material. In some embodiments, electrodes may be prefabricated and attached to an electroactive material. In some embodiments, an electrode may be deposited on a substrate, for example a glass substrate or flexible polymer film. In some embodiments, the electroactive material layer may directly abut an electrode. In some embodiments, there may be a dielectric layer, such as an insulating layer, between a layer of electroactive material and an electrode. Any suitable combination of processes and/or structures may be used.

### Dielectric Materials

According to some embodiments, an anti-reflective coating may include a conductive electrode, as described above, and one or more dielectric layers disposed over the electrode.

According to certain embodiments, a dielectric layer may include a material such as silicon dioxide, zinc oxide, aluminum oxide, and/or magnesium fluoride, although additional dielectric materials may be used. For instance, the dielectric layer may include one or more compounds selected from AlO₃, Bi₂O₃, CeO₂, Cr₂O₃, HfO₂, In₂O₃, MgO, MoO₃, La₂O₃, Nd₂O₃, PbO, SiO₂, Sm₂O₃, SnO₂, Ta₂O₅, TiO₂, Ti₄O₂, Ti₃O₅, Ti₂O₃, TiO, WO₃, Y₂O₃, ZrO₂, ZnO, BaF₂, CaF₂, CeF₃, AlF₃, BaF₂, CaF₂, CaF₃, LaF₃, LiF, MgF₂, NaF, PbF₂, SmF₃, SrF₂, and YF₃.

In some embodiments, the anti-reflective coating may include combinations of one or more of the aforementioned oxides and/or one or more of the aforementioned fluorides. Example anti-reflective coatings may include: (a) one of the above-identified oxides, (b) one of the above-identified fluorides, (c) two of the above-identified oxides, (d) one of the above-identified oxides combined with one of the above-identified fluorides, (e) two of the above-identified oxides combined with one of the above-identified fluorides, (f) two of the above-identified oxides combined with two of the above-identified fluorides, or (g) three of the above-identified oxides.

In some embodiments, the dielectric layer may include a first oxide layer, a second oxide layer, and an optional third oxide layer, where each of the oxide layers may include an oxide compound independently selected from AlO₃, Bi₂O₃, CeO₂, Cr₂O₃, HfO₂, In₂O₃, MgO, MoO₃, La₂O₃, Nd₂O₃, PbO, SiO₂, Sm₂O₃, SnO₂, Ta₂O₅, TiO₂, Ti₄O₂, Ti₃O₅, Ti₂O₃, TiO, WO₃, Y₂O₃, ZrO₂, and ZnO.

In further embodiments, the dielectric layer may include a first layer including an oxide compound selected from AlO₃, Bi₂O₃, CeO₂, Cr₂O₃, HfO₂, In₂O₃, MgO, MoO₃, La₂O₃, Nd₂O₃, PbO, SiO₂, Sm₂O₃, SnO₂, Ta₂O₅, TiO₂, Ti₄O₂, Ti₃O₅, Ti₂O₃, TiO, WO₃, Y₂O₃, ZrO₂, and ZnO, and a second layer including a fluoride compound selected from BaF₂, CaF₂, CeF₃, AlF₃, BaF₂, CaF₂, CaF₃, LaF₃, LiF, MgF₂, NaF, PbF₂, SmF₃, SrF₂, and YF₃. In some embodiments, the first layer may be disposed directly over the electroactive layer and the second layer may be disposed directly over the first layer. In other embodiments, the second layer may be disposed directly over the electroactive layer and the first layer may be disposed directly over the second layer.

In still further embodiments, the dielectric layer may include first and second oxide layers each independently selected from AlO₃, Bi₂O₃, CeO₂, Cr₂O₃, HfO₂, In₂O₃, MgO, MoO₃, La₂O₃, Nd₂O₃, PbO, SiO₂, Sm₂O₃, SnO₂, Ta₂O₅, TiO₂, Ti₄O₂, Ti₃O₅, Ti₂O₃, TiO, WO₃, Y₂O₃, ZrO₂, and ZnO, and a third layer including a fluoride compound selected from BaF₂, CaF₂, CeF₃, AlF₃, BaF₂, CaF₂, CaF₃, LaF₃, LiF, MgF₂, NaF, PbF₂, SmF₃, SrF₂, and YF₃. For such a structure, the third (fluoride) layer may be disposed between the first and second (oxide) layers. Alternatively, the third (fluoride) layer may be disposed between one of the oxide layers and the electroactive layer.

In certain embodiments, two or more dielectric layers may be formed sequentially. Alternatively, the dielectric materials may be co-deposited. For instance, the above-described combinations of oxides and fluorides may be deposited simultaneously rather than as discrete, sequential layers. Moreover, according to some embodiments, the composition of a dielectric layer may be varied spatially, e.g., throughout its thickness, by changing the relative ratio(s) of two or more co-deposited compounds. For each of the embodiments described, the oxide(s) and/or fluoride(s) in a given layer of the anti-reflective coating may be the same as or different than the oxide(s) and/or fluoride(s) in other layers.

A dielectric layer may have any suitable thickness, including, for example, a thickness of approximately 10 nm to approximately 1000 nm, e.g., approximately 10, 20, 50, 100, 200, 500, or 1000 nm, including ranges between any of the foregoing values, with an example thickness range of approximately 50 nm to approximately 100 nm.

In various embodiments, the dielectric layer(s) may be fabricated using any suitable process. For example, the dielectric layer(s) may be fabricated using physical vapor deposition (PVD), chemical vapor deposition (CVD), atomic layer deposition (ALD), evaporation, spray-coating, spin-coating, dip-coating, screen printing, Gravure printing, ink jet printing, aerosol jet printing, doctor blading, and the like. In further aspects, the electrodes may be manufactured using a thermal evaporator, a sputtering system, stamping, and the like.

### Optical Elements

In some applications, an optical element used in connection with the principles disclosed herein may include a primary electrode, a secondary electrode, and an electroactive layer disposed between the primary electrode and the secondary electrode. An anti-reflective coating (ARC), which may include the primary electrode or the secondary electrode as well as one or more additional dielectric layers, may be formed over respective surfaces of the electroactive layer.

In some embodiments, there may be one or more additional electrodes, and a common electrode may be electrically coupled to one or more of the additional electrodes. For example, optical elements may be disposed in a stacked configuration, with a first common electrode coupled to a first plurality of electrodes, and a second common electrode electrically connected to a second plurality of electrodes. The first and second pluralities may alternate in a stacked configuration, so that each optical element is located between one of the first plurality of electrodes and one of the second plurality of electrodes.

In some embodiments, an optical element may have a thickness of approximately 10 nm to approximately 300 μm (e.g., approximately 10 nm, approximately 20 nm, approximately 30 nm, approximately 40 nm, approximately 50 nm, approximately 60 nm, approximately 70 nm, approximately 80 nm, approximately 90 nm, approximately 100 nm, approximately 200 nm, approximately 300 nm, approximately 400 nm, approximately 500 nm, approximately 600 nm, approximately 700 nm, approximately 800 nm, approximately 900 nm, approximately 1 μm, approximately 2 μm, approximately 3 μm, approximately 4 μm, approximately 5 μm, approximately 6 μm, approximately 7 μm, approximately 8 μm, approximately 9μm, approximately 10 μm, approximately 20 μm, approximately 50 μm, approximately 100 μm, approximately 200 μm, or approximately 300 μm), with an example thickness of approximately 200 nm to approximately 500 nm.

The application of a voltage between the electrodes can cause compression or expansion of the intervening electroactive layer(s) in the direction of the applied electric field and an associated expansion or contraction of the electroactive layer(s) in one or more transverse dimensions. In some embodiments, an applied voltage (e.g., to the primary electrode and/or the secondary electrode) may create at least approximately 0.1% strain (e.g., an amount of deformation in the direction of the applied force resulting from the applied voltage divided by the initial dimension of the material) in the electroactive element(s) in at least one direction (e.g., an x, y, or z direction with respect to a defined coordinate system).

In some embodiments, the electroactive response may include a mechanical response to the electrical input that varies over the spatial extent of the device, with the electrical input being applied between the primary electrode and the secondary electrode. The mechanical response may be termed an actuation, and example devices or optical elements may be, or include, actuators.

The optical element may be deformable from an initial state to a deformed state when a first voltage is applied between the primary electrode and the secondary electrode and may further be deformable to a second deformed state when a second voltage is applied between the primary electrode and the secondary electrode.

An electrical signal may include a potential difference, which may include a direct or alternating voltage. In some embodiments, the frequency may be higher than the highest mechanical response frequency of the device, so that deformation may occur in response to the applied RMS electric field but with no appreciable oscillatory mechanical response to the applied frequency. The applied electrical signal may generate non-uniform constriction of the electroactive layer between the primary and secondary electrodes. A non-uniform electroactive response may include a curvature of a surface of the optical element, which may in some embodiments be a compound curvature.

In some embodiments, an optical element may have a maximum thickness in an undeformed state and a compressed thickness in a deformed state. In some embodiments, an optical element may have a density in an undeformed state that is approximately 90% or less of a density of the optical element in the deformed state. In some embodiments, an optical element may exhibit a strain of at least approximately 0.1% when a voltage is applied between the primary electrode and the secondary electrode.

In some embodiments, an optical device may include one or more optical elements, and an optical element may include one or more electroactive layers. In various embodiments, an optical element may include a primary electrode, a secondary electrode overlapping at least a portion of the primary electrode, and an electroactive layer disposed between the primary electrode and the secondary electrode.

In some embodiments, the application of an electric field over an entirety of an electroactive layer may generate substantially uniform deformation between the primary and secondary electrodes. In some embodiments, the primary electrode and/or the secondary electrode may be patterned, allowing a localized electric field to be applied to a portion of the optical element, for example, to provide a localized deformation.

An optical device may include a plurality of stacked elements. For example, each element may include an electroactive layer disposed between a pair of electrodes. In some embodiments, an electrode may be shared between elements; for example, a device may have alternating electrodes and an electroactive layer located between neighboring pairs of electrodes. Various stacked configurations can be constructed in different geometries that alter the shape, alignment, and spacing between elements. Such complex arrangements can enable compression, extension, twisting, and/or bending when operating such an actuator.

In some embodiments, an optical device may include additional elements interleaved between electrodes, such as in a stacked configuration. For example, electrodes may form an interdigitated stack of electrodes, with alternate electrodes connected to a first common electrode and the remaining alternate electrodes connected to a second common electrode. An additional optical element may be disposed on the other side of a primary electrode. The additional optical element may overlap a first optical element. An additional electrode may be disposed abutting a surface of any additional optical element.

In some embodiments, an optical device may include more (e.g., two, three, or more) such additional electroactive layers and corresponding electrodes. For example, an optical device may include a stack of two or more optical elements and corresponding electrodes. For example, an optical device may include between 2 optical elements to approximately 5, approximately 10, approximately 20, approximately 30, approximately 40, approximately 50, approximately 100, approximately 200, approximately 300, approximately 400, approximately 500, approximately 600, approximately 700, approximately 800, approximately 900, approximately 1000, approximately 2000, or greater than approximately 2000 optical elements.

### Fabrication of Optical Elements

Various fabrication methods are discussed herein. As will be appreciated by one skilled in the art, the disclosed fabrication methods may be used to form one or more layers or features within an optical element, including organic (i.e., polymeric) and inorganic (i.e., ceramic) electroactive materials, transparent conductive electrodes disposed adjacent to such electroactive materials, and one or more dielectric layers. In certain embodiments, the structure and properties of an optical element may be varied, e.g., across a spatial extent, by varying one or more process parameters, such as wavelength, intensity, substrate temperature, other process temperature, gas pressure, radiation dosage, chemical concentration gradients, chemical composition variations, or other process parameter(s).

According to some embodiments, deposition methods, including spin-coating, screen printing, inkjet printing, evaporation, chemical vapor deposition, vapor coating, physical vapor deposition, thermal spraying, extrusion, hydrothermal synthesis, Czochralski growth, isostatic pressing, lamination, etc., may be used to form an electroactive layer, electrode and/or dielectric layer. In certain embodiments, an electrode may be deposited directly onto an electroactive layer and a dielectric layer may be deposited directly onto the electrode. In alternate embodiments, an electroactive layer may be deposited onto a provisional substrate and transferred to an electrode or an electroded substrate.

In some embodiments, an electroactive layer, an electrode or a dielectric layer may be fabricated on a surface (e.g., substrate) enclosed by a deposition chamber, which may be evacuated (e.g., using one or more mechanical vacuum pumps to a predetermined level such as 10⁻⁶ Torr or below). A deposition chamber may include a rigid material (e.g., steel, aluminum, brass, glass, acrylic, and the like). A surface used for deposition may include a rotating drum. In some embodiments, the rotation may generate centrifugal energy and cause the deposited material to spread more uniformly over any underlying sequentially deposited materials (e.g., electrodes, polymer elements, ceramic elements, and the like) that are mechanically coupled (e.g., bonded) to the surface. In some embodiments, the surface may be fixed and deposition and curing systems may move relative to the surface, or both the surface, the deposition, and/or curing systems may be moving simultaneously.

In some embodiments, a deposition chamber may have an exhaust port configured to open to release at least a portion of reaction by-products, as well as monomers, oligomers, monomer initiators, conductive materials, etc. associated with the formation of one or more material layers. In some embodiments, a deposition chamber may be purged (e.g., with a gas or the application of a vacuum, or both) to remove such materials. Thereafter, one or more of the previous steps may be repeated (e.g., for a second optical element, and the like). In this way, individual layers of an optical element may be maintained at high purity levels.

In some embodiments, the deposition of the materials (e.g., monomers, oligomers, monomer initiators, conductive materials, dielectric layers, etc.) of the optical element may be performed using a deposition process, such as chemical vapor deposition (CVD). CVD may refer to a vacuum deposition method used to produce high-quality, high-performance, solid materials. In CVD, a substrate may be exposed to one or more precursors, which may react and/or decompose on the substrate surface to produce the desired deposit (e.g., one or more electrodes, electroactive polymer layers, etc.). Frequently, volatile by-products are also produced, which may be removed by gas flow through the chamber.

In some embodiments, methods for fabricating an optical element (e.g., an actuator) may include masks (e.g., shadow masks) to control the patterns of one or more deposited materials.

Methods of forming an optical element include forming a dielectric layer, electrodes and an electroactive layer sequentially (e.g., via vapor deposition, coating, printing, etc.) or simultaneously (e.g., via co-flowing, coextrusion, slot die coating, etc.). By way of example, an electroactive layer may be deposited using initiated chemical vapor deposition (iCVD), where suitable monomers of the desired polymers may be used to form the desired coating. According to a further example, a co-extrusion process having a high drawing ratio may enable the formation of plural thin layers (e.g., electroactive layers, electrode layers and/or dielectric layers), which may be used to form a multi-morph architecture from a larger billet of electroactive, conductive, and optionally passive support materials. Alternatively, the electroactive layers may be extruded individually.

A method of fabricating an optical element may include depositing a curable material onto a primary electrode, curing the deposited curable material to form an electroactive layer (e.g., including a cured elastomer material) and depositing an electrically conductive material onto a surface of the electroactive layer opposite the primary electrode to form a secondary electrode. A dielectric layer may, in turn, be deposited over one or both of the primary electrode and the secondary electrode. In some embodiments, a method may further include depositing an additional curable material onto a surface of the secondary electrode opposite the electroactive layer, curing the deposited additional curable material to form a second electroactive layer including a second cured elastomer material, and depositing an additional electrically conductive material onto a surface of the second electroactive layer opposite the secondary electrode to form a tertiary electrode. In such case, a dielectric layer may be deposited over the tertiary electrode.

In some embodiments, a method of fabricating an optical element may include vaporizing a curable material, or a precursor thereof, where depositing the curable material may include depositing the vaporized curable material onto a primary electrode. In some embodiments, a method of fabricating an optical element may include printing the polymer or precursor thereof (such as a curable material) onto an electrode. In some embodiments, a method may also include combining a polymer precursor material with at least one other component to form a deposition mixture. In some embodiments, a method may include combining a curable material with particles of a material having a high dielectric constant to form a deposition mixture.

According to some embodiments, a method may include positioning a curable material between a first electrically conductive material or layer and a second electrically conductive material or layer. The positioned curable material may be cured to form a cured elastomer material. In some embodiments, the cured elastomer material may have a Poisson's ratio of approximately 0.35 or less. In some embodiments, at least one of the first electrically conductive material or the second electrically conductive material may include a curable electrically conductive material, and the method may further include curing the at least one of the first electrically conductive material or the second electrically conductive material to form an electrode. In this example, curing the at least one of the first electrically conductive material or the second electrically conductive material may include curing the at least one of the first electrically conductive material or the second electrically conductive material during curing of the positioned curable material.

In some embodiments, a curable material and at least one of a first electrically conductive material or a second electrically conductive material may be flowable during positioning of the curable material between the primary and secondary electrodes. A method of fabricating an optical element may further include flowing a curable material and at least one of the first electrically conductive material or the second electrically conductive material simultaneously onto a substrate.

In some embodiments, an optical element (e.g., actuator) may be fabricated by providing an electrically conductive layer (e.g., a primary electrode) having a first surface, depositing (e.g., vapor depositing) an electroactive layer or precursor layer onto the primary electrode, and depositing another electrically conductive layer (e.g., a secondary electrode) onto the electroactive (or precursor) layer. In some embodiments, the method may further include repeating one or more of the above to fabricate additional layers (e.g., a second optical element, other electrodes, alternating stacks of electroactive layers and electrodes, and the like. An optical device may have a stacked configuration. In some embodiments, the method may include depositing a dielectric layer over the primary electrode or over the secondary electrode on respective surfaces opposite the electroactive layer.

In some embodiments, an optical element may be fabricated by first depositing a primary electrode, and then depositing a curable material (e.g., a monomer) on the primary electrode (e.g., deposited using a vapor deposition process). In some embodiments, an inlet to a deposition chamber may open and may input an appropriate monomer initiator for starting a chemical reaction. In some embodiments, “monomer,” as used herein, may refer to a monomer that forms a given polymer (i.e., as part of an electroactive element). In other examples, polymerization (i.e., curing) of a polymer precursor such as a monomer may include exposure to electromagnetic radiation (e.g., visible, UV, x-ray or gamma radiation), exposure to other radiation (e.g., electron beams, ultrasound), heat, exposure to a chemical species (such as a catalyst, initiator, and the like), or some combination thereof.

Deposited curable material may be cured with a source of radiation (e.g., electromagnetic radiation, such as UV radiation and/or visible light) to form an electroactive polymer layer that includes a cured elastomer material, for example by photopolymerization. In some embodiments, a radiation source may include an energized array of filaments that may generate electromagnetic radiation, a semiconductor device such as a light-emitting diode (LED) or semiconductor laser, other laser, fluorescence or an optical harmonic generation source, and the like. A monomer and an initiator (if used) may react upon exposure to radiation to form an electroactive element.

In some embodiments, radiation may include radiation having an energy (e.g., intensity and/or photon energy) capable of breaking covalent bonds in a material. Radiation examples may also include electrons, electron beams, ions (such as protons, nuclei, and ionized atoms), x-rays, gamma rays, ultraviolet light, visible light, or other radiation, e.g., having appropriately high energy levels.

In some embodiments, an optical element may be fabricated using an atmospheric pressure CVD (APCVD) coating formation technique (e.g., CVD at atmospheric pressure). In some embodiments, an optical element may be fabricated using a low-pressure CVD (LPCVD) process (e.g., CVD at sub-atmospheric pressures). In some embodiments, LPCVD may make use of reduced pressures that may reduce unwanted gas-phase reactions and improve the deposited material's uniformity across a substrate. In one aspect, a fabrication apparatus may apply an ultrahigh vacuum CVD (UHVCVD) process (e.g., CVD at very low pressure, typically below approximately 10⁻⁶ Pa (equivalently, approximately 10⁻⁸ torr)).

In some embodiments, an optical element may be fabricated using an aerosol assisted CVD (AACVD) process (e.g., a CVD process in which the precursors are transported to the substrate by means of a liquid/gas aerosol), which may be generated ultrasonically or with electrospray. In some embodiments, AACVD may be used with non-volatile precursors. In some embodiments, an optical element may be fabricated using a direct liquid injection CVD (DLI-CVD) process (e.g., a CVD process in which the precursors are in liquid form, for example, a liquid or solid dissolved in a solvent). Liquid solutions may be injected in a deposition chamber using one or more injectors. Precursor vapors may then be transported as in CVD. DLI-CVD may be used on liquid or solid precursors, and high growth rates for the deposited materials may be achieved using this technique.

In some embodiments, an optical element may be fabricated using a hot wall CVD process (e.g., CVD in which the deposition chamber is heated by an external power source and the deposited layer(s) are heated by radiation from the heated wall of the deposition chamber). In another aspect, an optical element may be fabricated using a cold wall CVD process (e.g., a CVD process in which only the device is directly heated, for example, by induction, while the walls of the chamber are maintained at room temperature).

In some embodiments, an optical element may be fabricated using a microwave plasma-assisted CVD (MPCVD) process, where microwaves are used to enhance chemical reaction rates of the precursors. In another aspect, an optical element may be fabricated using a plasma-enhanced CVD (PECVD) process (e.g., CVD that uses plasma to enhance chemical reaction rates of the precursors). In some embodiments, PECVD processing may allow deposition of materials at lower temperatures, which may be useful in withstanding damage to the device or in depositing certain materials (e.g., organic materials and/or some polymers).

In some embodiments, an optical element may be fabricated using a remote plasma-enhanced CVD (RPECVD) process. In some embodiments, RPECVD may be similar to PECVD except that the optical element or device may not be directly in the plasma discharge region. In some embodiments, the removal of the electroactive device from the plasma region may allow for the reduction of processing temperatures down to approximately room temperature (i.e., approximately 23° C.).

In some embodiments, an optical element may be fabricated using an atomic-layer CVD (ALCVD) process. In some embodiments, ALCVD may deposit successive layers of different substances to produce layered, crystalline thin films.

In some embodiments, an optical element may be fabricated using a combustion chemical vapor deposition (CCVD) process. In some embodiments, CCVD (also referred to as flame pyrolysis) may refer to an open-atmosphere, flame-based technique for depositing high-quality thin films (e.g., layers of material ranging from fractions of a nanometer (monolayer) to several micrometers in thickness).

In some embodiments, an optical element may be fabricated using a hot filament CVD (HFCVD) process, which may also be referred to as catalytic CVD (cat-CVD) or initiated CVD (iCVD). In some embodiments, this process may use a hot filament to chemically decompose source gases to form the materials of the device. Moreover, the filament temperature and temperature of portions of the deposited layers may be independently controlled, allowing colder temperatures for better adsorption rates at the growth surface, and higher temperatures necessary for decomposition of precursors to free radicals at the filament.

In some embodiments, an optical element may be fabricated using a hybrid physical-chemical vapor deposition (HPCVD) process. HPCVD may involve both chemical decomposition of precursor gas and vaporization of a solid source to form the materials of the optical element.

In some embodiments, an optical element may be fabricated using a metalorganic chemical vapor deposition (MOCVD) process (e.g., a CVD method that uses metalorganic precursors to form one or more layers of an optical element). For example, an electrode may be formed on an electroactive layer using this approach.

In some embodiments, an optical element may be fabricated using a rapid thermal CVD (RTCVD) process. This CVD process uses heating lamps or other methods to rapidly heat the optical element. Heating only the optical element during fabrication thereof rather than the precursors or chamber walls may reduce unwanted gas-phase reactions that may lead to particle formation in one or more layers of the optical element.

In some embodiments, an optical element may be fabricated using a photo-initiated CVD (PICVD) process. This process may use UV light to stimulate chemical reactions in the precursor materials used to make the materials for the optical element. Under certain conditions, PICVD may be operated at or near atmospheric pressure.

In some embodiments, optical elements may be fabricated by a process including depositing a curable material (e.g., a monomer such as an acrylate or a silicone) and a solvent for the curable material onto a substrate, heating the curable material with at least a portion of the solvent remaining with the cured monomer, and removing the solvent from the cured monomer.

In some embodiments, a flowable material (e.g., a solvent) may be combined with the curable materials (e.g., monomers and conductive materials) to create a flowable mixture that may be used for producing electroactive polymers. The monomers may be monofunctional or polyfunctional, or mixtures thereof. Polyfunctional monomers may be used as crosslinking agents to add rigidity or to form elastomers. Polyfunctional monomers may include difunctional materials such as bisphenol fluorene (EO) diacrylate, trifunctional materials such as trimethylolpropane triacrylate (TMPTA), and/or higher functional materials. Other types of monomers may be used, including, for example, isocyanates, and these may be mixed with monomers with different curing mechanisms.

In some embodiments, the flowable material may be combined (e.g., mixed) with a curable material. In some embodiments, a curable material may be combined with at least one non-curable component (e.g., particles of a material having a high dielectric constant) to form a mixture including the curable material and the at least one non-curable component, for example, on an electrode (e.g., a primary electrode or a secondary electrode). Alternatively, the flowable material (e.g., solvent) may be introduced into a vaporizer to deposit (e.g., via vaporization or, in alternative embodiments, via printing) a curable material onto an electrode. In some embodiments, a flowable material (e.g., solvent) may be deposited as a separate layer either on top or below a curable material (e.g., a monomer) and the solvent and curable material may be allowed to inter-diffuse before being cured by a source of radiation to generate an electroactive polymer.

In some embodiments, after the curable material is cured, the solvent may be allowed to evaporate before another electroactive layer or another electrode is formed. In some embodiments, the evaporation of the solvent may be accelerated by the application of heat to the surface with a heater, which may, for example, be disposed within a drum forming surface and/or any other suitable location, or by reducing the pressure of the solvent above the substrate using a cold trap (e.g., a device that condenses vapors into a liquid or solid), or a combination thereof.

In some embodiments, the solvent may have a vapor pressure that is similar to at least one of the monomers being evaporated. The solvent may dissolve both the monomer and the generated electroactive polymer, or the solvent may dissolve only the monomer. Alternatively, the solvent may have low solubility for the monomer, or plurality of monomers if there is a mixture of monomers being applied. Furthermore, the solvent may be immiscible with at least one of the monomers and may at least partially phase separate when condensed on the substrate.

In some embodiments, there may be multiple vaporizers, with each of the multiple vaporizers applying a different material, including solvents, non-solvents, monomers, and/or ceramic precursors such as tetraethyl orthosilicate and water, and optionally a catalyst, such as HCI or ammonia, for forming a sol-gel, for example.

In some embodiments, a method of generating an electroactive layer for use in connection with an optical element (such as reflective or transparent actuators described variously herein) may include co-depositing a monomer or mixture of monomers, a surfactant, and a non-solvent material associated with the monomer(s) that is compatible with the surfactant.

In various examples, the monomer(s) may include, but not be limited to, ethyl acrylate, butyl acrylate, octyl acrylate, ethoxy ethyl acrylate, 2-chloroethyl vinyl ether, chloromethyl acrylate, methacrylic acid, allyl glycidyl ether, and/or N-methylol acrylamide.

In some aspects, the surfactant may be ionic or non-ionic (for example SPAN 80, available from Sigma-Aldrich Company). In another aspect, the non-solvent material may include organic and/or inorganic non-solvent materials. For instance, the non-solvent material may include water or a hydrocarbon or may include a highly polar organic compound such as ethylene glycol. As noted, the monomer or monomers, non-solvent, and surfactant may be co-deposited. Alternatively, the monomer or monomers, non-solvent, and/or surfactant may be deposited sequentially.

In one aspect, a substrate temperature may be controlled to generate and control one or more properties of the resulting emulsion generated by co-depositing or sequentially depositing the monomer or monomers, non-solvent, and surfactant. The substrate may be treated to prevent destabilization of the emulsion. For example, an aluminum layer may be coated with a thin polymer layer made by depositing a monomer followed by curing the monomer. In accordance with various embodiments, a substrate may include an electrode (e.g., a primary electrode or a secondary electrode).

A curing agent, if provided, may include polyamines, higher fatty acids or their esters, sulfur, or a hydrosilylation catalyst, for example. In some embodiments, a mixture of curable monomers with cured polymers may be used. Furthermore, stabilizers may be used, for example, to inhibit environmental degradation of the electroactive polymer. Example stabilizers include antioxidants, light stabilizers and heat stabilizers.

Ceramic electroactive materials, such as single crystal piezoelectric materials, may be formed, for example, using hydrothermal processing or by a Czochralski method to produce an oriented ingot, which may be cut along a specified crystal plane to produce wafers having a desired crystalline orientation. A wafer may be thinned, e.g., via lapping, or polished, and transparent electrodes may be formed directly on the wafer, e.g., using chemical vapor deposition or a physical vapor deposition process such as sputtering or evaporation. Optionally, the electroactive ceramic may be poled to achieve a desired dipole alignment.

In addition to the foregoing, polycrystalline piezoelectric materials may be formed, e.g., by powder processing. Densely-packed networks of high purity, ultrafine polycrystalline particles can be highly transparent and may be more mechanically robust in thin layers than their single crystal counterparts. For instance, optical grade PLZT having >99.9% purity may be formed using sub-micron (e.g., <2 μm) particles. In this regard, substitution via doping of Pb²⁺ at A and B-site vacancies with La²⁺ and/or Ba²⁺ may be used to increase the transparency of perovskite ceramics such as PZN-PT, PZT and PMN-PT.

According to some embodiments, ultrafine particle precursors can be fabricated via wet chemical methods, such as chemical co-precipitation, sol-gel and gel combustion. Green bodies may be formed using tape casting, slip casting, or gel casting. High pressure and high temperature sintering via techniques such as hot pressing, high pressure (HP) and hot isostatic pressure, spark plasma sintering, and microwave sintering, for example, may be used to improve the ceramic particle packing density. Thinning via lapping and/or polishing may be used to decrease surface roughness to achieve thin, highly optically transparent layers that are suitable for high displacement actuation.

As will be appreciated, the methods and systems shown and described herein may be used to form electroactive devices having a single layer or multiple layers of an electroactive material (e.g., a few layers to tens, hundreds, or thousands of stacked layers). For example, an electroactive device may include a stack of from two electroactive elements and corresponding electrodes to thousands of electroactive elements (e.g., approximately 5, approximately 10, approximately 20, approximately 30, approximately 40, approximately 50, approximately 100, approximately 200, approximately 300, approximately 400, approximately 500, approximately 600, approximately 700, approximately 800, approximately 900, approximately 1000, approximately 2000, or greater than approximately 2000 electroactive elements, including ranges between any of the foregoing values). A large number of layers may be used to achieve a high displacement output, where the overall device displacement may be expressed as the sum of the displacement of each layer. Such complex arrangements can enable compression, extension, twisting, and/or bending when operating the electroactive device.

Thus, single-layer, bi-layer, and multi-layer optical element architectures are disclosed, and may optionally include pre-strained electroactive layers, e.g., elastomeric layers. By way of example, a pre-tensioned stack may be formed by a lamination process. In conjunction with such a process, a rigid frame may be used to maintain line tension within the polymer layer(s) during lamination. Further manufacturing methods for the optical elements are disclosed, including the formation of a buckled layer by thermoforming about a mold, which may be used to achieve a desired piezoelectric response while potentially obviating the need for introducing (and maintaining) layer pre-tension. Also disclosed are various augmented reality stack designs and lens geometries based on buckled layer or molded layer paradigms.

As will be explained in greater detail below, embodiments of the instant disclosure relate to an anti-reflective coating having an optically transparent electrically conductive layer disposed over an electroactive layer and a dielectric layer disposed over the electrically conductive layer.

An optical element including an anti-reflective coating may include a transparent electroactive layer, a primary anti-reflective coating disposed over a first surface of the electroactive layer, and a secondary anti-reflective coating disposed over a second surface of the electroactive layer opposite the first surface. As will be appreciated, the primary anti-reflective coating may include a primary conductive layer disposed directly over the first surface of the electroactive layer and a primary dielectric layer disposed over the primary conductive layer, whereas the secondary anti-reflective coating may include a secondary conductive layer disposed directly over the second surface of the electroactive layer and a secondary dielectric layer disposed over the secondary conductive layer.

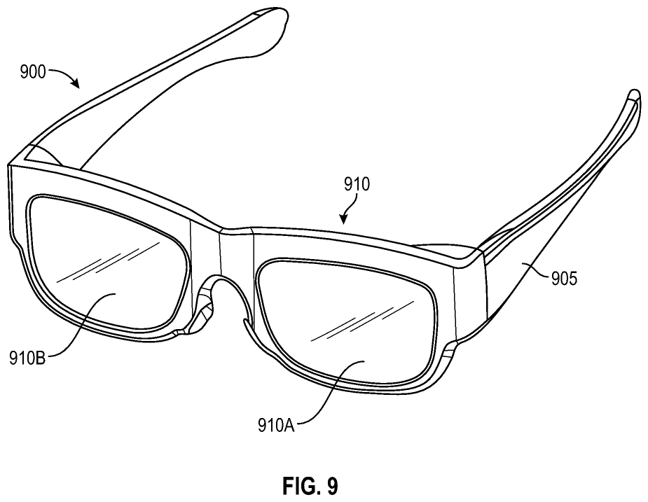

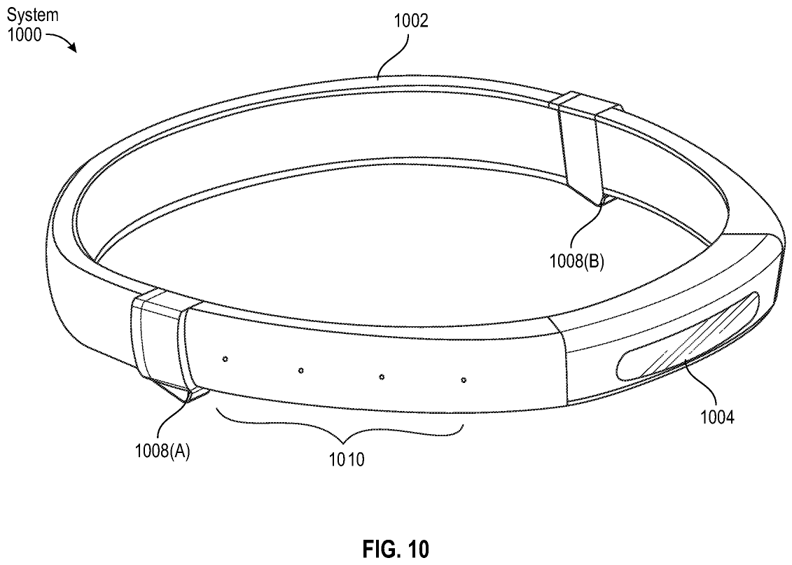

The following will provide, with reference to FIGS. 1-12, a detailed description of methods, systems, and apparatuses for forming actively tunable optical elements that include an anti-reflective coating. The discussion associated with FIGS. 1-5 includes a description of example anti-reflective coating architectures. The discussion associated with FIGS. 6 and 7 includes a description of anti-reflective coating structures with one or more layers having a graded refractive index. The discussion associated with FIG. 8 includes a description of an optical element having an anti-reflective coating disposed over opposing surfaces thereof. FIG. 9 shows a schematic illustration of a head-mounted display. The discussion associated with FIGS. 10-12 relates to exemplary virtual reality and augmented reality devices that may include an optical element having an anti-reflective coating.

An example electroactive ceramic is lead zirconate titanate (PZT). Although various PZT-containing optical elements are described herein, the present disclosure is not particularly limited, and anti-reflective coatings may be incorporated into optical elements that include other electroactive materials.

In various embodiments, the thickness of one or more ARC layers disposed over the electroactive material may be determined using a model that includes the optical constants (e.g., refractive indices) of the layers.

For a dense PZT thin film, the PZT-air interface has been shown to have a wavelength averaged reflectivity of about 20.8% and a transmissivity of only about 79.2% for normal incidence. In further trials, the reflectivity increases, and the transmissivity decreases for increasingly off-axis (non-normal) light. In accordance with various embodiments, the formation of an anti-reflective coating over the PZT layer can increase the transmissivity and correspondingly decrease reflectivity.

The formation of a thin (approximately 69 nm), tin-doped indium oxide (ITO) layer over the PZT may decrease the reflectivity of the air/PZT interface from 20.8% to approximately 4% averaged across wavelengths from 400 to 700 nm (Example 2). The ITO layer also increases the transmissivity to approximately 95.2%, with approximately 0.8% absorption.

Referring to FIG. 1, an example optical element may include an electroactive layer 100 and an anti-reflective coating 400 disposed over a surface of the electroactive layer 100. The anti-reflective coating 400 may include an electrically conductive layer (i.e., electrode) 210 disposed directly over the electroactive layer 100 and a dielectric layer 310 disposed directly over the electrically conductive layer 210. The electrode 210 and the dielectric layer 310 may respectively include any suitable electrically conductive and dielectric material, as disclosed herein.

According to various embodiments, the electrically conductive layer 210 may include ITO and the dielectric layer 310 may include, for example, silicon dioxide, aluminum oxide or magnesium fluoride. Modeled layer thicknesses and the corresponding maximum transmissivity, minimum reflectivity, and absorption data for example structures are summarized in Table 1 (Examples 3-5).

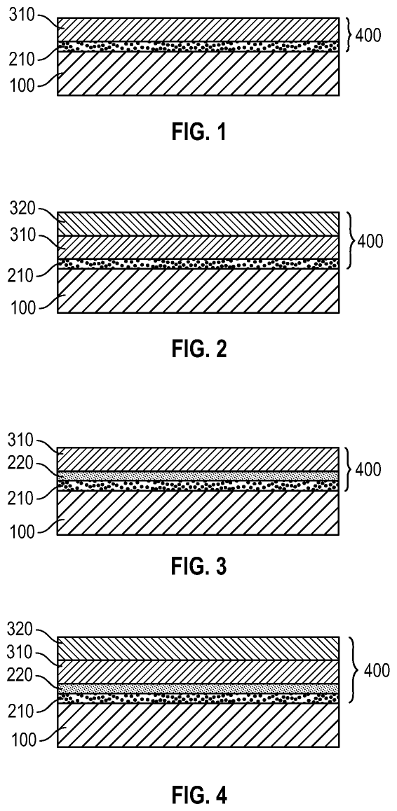

In some embodiments, an anti-reflective coating may include a multi-layer (e.g., bilayer) dielectric. Referring to FIG. 2, for instance, an optical element may include an electroactive layer 100 and an anti-reflective coating 400 disposed over a top surface of the electroactive layer 100. The anti-reflective coating 400 may include an electrically conductive layer 210 (e.g., an electrode) disposed directly over the electroactive layer 100, a first dielectric layer 310 disposed over the electrically conductive layer 210 and a second dielectric layer 320 disposed over the first dielectric layer 310. The electrically conductive layer 210 and the dielectric layers 310, 320 may include any suitable electrically conductive material and dielectric material, respectively, as disclosed herein.

In certain embodiments, a dielectric bilayer may be used to decrease the reflectivity of the electroactive layer. For instance, an un-electroded structure including a dielectric bilayer including a 69 nm silicon dioxide layer disposed over a 41 nm zinc oxide layer may exhibit a reflectivity of approximately 0.8% and have a corresponding transmissivity of approximately 99.2%.

As illustrated in FIG. 2, an example anti-reflective coating 400 may include an SiO₂-ZnO bilayer 310, 320 disposed over an ITO electrode 210. For instance, a zinc oxide layer 310 may be disposed over the electrically conductive layer 210 and a silicon dioxide layer 320 may be disposed over the zinc oxide layer 310 (Example 6).

In lieu of, or in addition to ITO, conductive layer 210 may include graphene. Referring still to FIG. 2, an example anti-reflective coating 400 may include a monolayer or bilayer of graphene 210 disposed over electroactive layer 100, and a dielectric bilayer including a zinc oxide layer 310 and a silicon dioxide layer 320 disposed over the conductive layer 210 (Example 7). Without wishing to be bound by theory, a relatively thin layer of graphene may not substantially impact the reflection of an anti-reflective coating but may introduce angle-dependent absorptive losses of up to approximately 1%.

According to further embodiments, higher conductivity and adequate transmissivity may be obtained using an anti-reflective coating that includes a multi-layer electrode, as illustrated schematically in FIG. 3. Formed over electroactive layer 100, the anti-reflective coating 400 of FIG. 3 may include a first electrically conductive layer 210 disposed over the electroactive layer 100, a second electrically conductive layer 220 disposed over the first electrically conductive layer 210, and a dielectric layer 310 disposed over the second electrically conductive layer 220. By way of example, first electrically conductive layer 210 may include graphene and second electrically conductive layer 220 may include ITO (Example 8).

According to further embodiments, and with reference to FIG. 4, an optical element may include a multi-layer anti-reflective coating 400 disposed over a surface of an electroactive layer 100. In the FIG. 4 embodiment, anti-reflective coating 400 may include, from bottom to top, a first electrically conductive layer 210, a second electrically conductive layer 220, a first dielectric layer 310, and a second dielectric layer 320. Each of first and second electrically conductive layers 210, 220 and first and second dielectric layers 310, 320 may include any suitable electrically conductive material(s) and dielectric material(s), respectively, as disclosed herein.

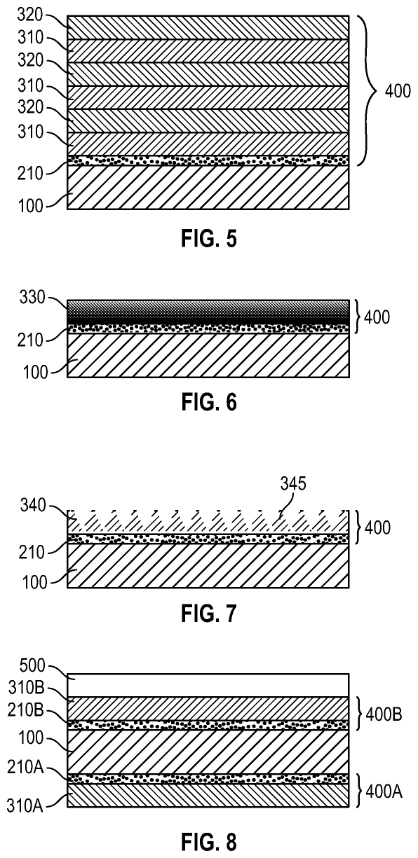

A further multi-layer anti-reflective coating is illustrated schematically in FIG. 5. Antireflective coating 400 is disposed over electroactive layer 100 and includes electrically conductive layer 210 and an overlying stack of alternating dielectric layers 310, 320. Dielectric layers 310, 320 may include, for example, zinc oxide and silicon dioxide, respectively.

Referring to FIG. 6, an antireflective coating 400 may include a graded index layer 330 disposed over an electrically conductive layer 210. Graded index layer 330 may include a compositionally-varying dielectric layer, such as an SiO₂-TiO₂ composite layer having a gradient in one or both of the SiO₂ and TiO₂ compositions, i.e., as a function of layer thickness. A compositional gradient may be achieved by varying a source gas flow rate ratio, e.g., during deposition of the layer 330. The graded composition and the associated graded refractive index may operate to decrease the reflectivity of light incident on the optical element.

In further embodiments, a dielectric layer having a graded refractive index may be formed by creating a textured dielectric layer. As shown in FIG. 7, antireflective coating 400 may include a textured dielectric layer 340. Textured dielectric layer 340 may include raised features 345, which may be shaped and positioned to affect a local change in the refractive index of the dielectric layer 340, i.e., as a function of thickness. In some embodiments, a “textured” layer may include any suitable surface relief structure, such as a Motheye texture, configured to decrease reflection. For instance, a textured layer may include an array of pyramidal surface structures that provide a gradual change in refractive index for light propagating from an adjacent material, e.g., air, into the dielectric layer. With such a textured structure, reflective losses may be decreased for broadband light incident over a wide angular range.

A textured dielectric layer 340 may be formed using conventional photolithography and etching techniques, as understood by those skilled in the art. Referring still to FIG. 7, while triangular raised features 345 are illustrated, other features shapes may be used. Example feature shapes include, but are not limited to, cylinders, anti-cylinders, spheres, anti-spheres, pyramids, anti-pyramids, rectangular prisms, anti-rectangular prisms, hemispheres, and anti-hemispheres, which may be periodic or aperiodic. Combinations of multiple different shapes may be used.

In addition to the modeled ARC structures summarized in each of Examples 1-8, which assume an air (n=1) interface, an optical element may include an active optical layer disposed over the anti-reflective coating. For example, an additional optical layer may include a liquid lens (LL). According to some embodiments, a liquid lens may directly overlie the anti-reflective coating. In this vein, Examples 9-14 refer to various optical element architectures that include a liquid lens having a dispersion-free refractive index of 1.58. As can be seen with reference to the baseline structure of Example 9, the formation of an ARC between the electroactive element and the liquid lens may appreciably increase transmissivity and decrease reflection from such an optical element.

In accordance with various embodiments, the modeled data in Table 1 summarizes ARC layer thicknesses to achieve a maximum averaged transmissivity for normal incidence over the range of 400 nm to 700 nm for each architecture. In further embodiments, other parameters may be targeted, including transmissivity for off-axis incidence and/or different wavelengths of incident light. For instance, in some embodiments the refractive index of the electroactive layer may change under an applied electric field, and it may be desirable for an overlying ARC to have a maximum transmissivity while an actuating electric field is applied, rather than when the electric field is not applied.

An example optical element is shown in FIG. 8. The optical element includes an electroactive layer 100, a primary anti-reflective coating 400a formed over one surface of the electroactive layer 100 and a secondary anti-reflective coating 400b formed over an opposing surface. The primary anti-reflective coating 400a includes a primary electrically conductive layer 210a formed over the electroactive layer 100 and a primary dielectric layer 310a formed over the primary electrically conductive layer 210a. The secondary anti-reflective coating 400b includes a secondary electrically conductive layer 210b formed over the electroactive layer 100 and a secondary dielectric layer 310b formed over the secondary electrically conductive layer 210b. A liquid lens 500 is disposed over the secondary anti-reflective coating 400b, i.e., directly over the secondary dielectric layer 310b.

Each of the primary and secondary electrically conductive layers 210a, 210b and primary and secondary dielectric layers 310a, 310b may include any suitable electrically conductive material(s) and dielectric material(s), as disclosed herein. An example modeled structure may include, from bottom to top, 60 nm SiO₂, 40 nm ITO, PZT, 65 nm ITO, 160 nm SiO₂, and the liquid lens 500.

TABLE 1
OPTICAL ELEMENTS WITH AN
ANTI-REFLECTIVE COATING

| | | Trans- | Reflec- | Absorp- |
|---|---|---|---|---|
| | Optical Element | mission | tion | tion |
| Ex. | (thickness in nm) | (%) | (%) | (%) |
| 1 | air/ITO | 85 | 15 | |
| 2 | air/ITO (69)/PZT | 95.2 | 4 | 0.8 |
| 3 | air/SiO2 (60)/ITO (40)/PZT | 98.7 | 0.9 | 0.4 |
| 4 | air/Al2O3 (56)/ITO (17)/PZT | 97.8 | 2.1 | 0.1 |
| 5 | air/MgF2 (65)/ITO (49)/PZT | 98.8 | 0.7 | 0.5 |
| 6 | air/SiO2 (65)/ZnO (9)/ITO | 98.9 | 0.9 | 0.2 |
| | (29)/PZT | | | |
| 7 | air/SiO2 (69)/ZnO (41)/C | 99.2 | 0.8 | |
| | (0.35)/PZT | | | |
| 8 | air/SiO2 (61)/ITO (41)/C | 97.7 | 1 | 1.3 |
| | (0.35)/PZT | | | |
| 9 | LL/PZT | 93.3 | 6.7 | |
| 10 | LL/SiO2 (160)/ITO (65)/ | 98.4 | 0.8 | 0.8 |
| | PZT | | | |
| 11 | LL/Al2O3 (21)/ITO (53)/ | 98 | 1.4 | 0.6 |
| | PZT | | | |
| 12 | LL/MgF2 (176)/ITO (65)/ | 98.7 | 0.6 | 0.7 |
| | PZT | | | |
| 13 | LL/SiO2 (170)/ZnO (61)/ | 99.5 | 0.5 | |
| | PZT | | | |
| 14 | LL/SiO2 (172)/ZnO (61)/ | 98.6 | 0.5 | 0.9 |
| | C (0.35)/PZT | | | |

In the foregoing examples, the area of the electrodes (e.g., the primary and secondary electrodes) may be equal to or substantially equal to the area of the intervening electroactive layer. As used herein, values that are “substantially equal” may, in some examples, differ by at most 10%, e.g., approximately 1, 2, 4, or 10%, including ranges between any of the foregoing values.

According to some embodiments, patterned electrodes (e.g., one or both of a primary electrode and a secondary electrode) may be used to actuate one or more regions within an intervening electroactive layer, i.e., to the exclusion of adjacent regions within the same electroactive layer. For example, spatially-localized actuation of optical elements that include a polymeric electroactive layer can be used to tune the birefringence of such structure, where the birefringence may be a function of local mechanical stress.

In some embodiments, such plural (patterned) secondary electrodes may be independently actuatable or, as illustrated, actuated in parallel. Patterned electrodes may be formed by selective deposition of an electrode layer or by blanket deposition of an electrode layer followed by patterning and etching, e.g., using photolithographic techniques, as known to those skilled in the art. For instance, a patterned electrode may include a wire grid, or a wire grid may be incorporated into an optical element as a separate layer adjacent to an electrode layer.

In accordance with various embodiments, the optical transmissivity (see-through performance) of a tunable actuator may be improved by incorporating an anti-reflective coating (ARC) into the actuator stack. The actuator may include a layer of electroactive material sandwiched between conductive electrodes. The electroactive layer may include a polymer or ceramic material, for example, whereas the electrodes may each include one or more layers of any suitable conductive material(s), such as transparent conductive oxides (e.g., TCOs such as ITO), graphene, etc.

A dielectric layer may be disposed over either or both electrodes and may include one or more material layers used to decrease the gradient in refractive index between the electrode and an adjacent medium, such as air or a silicone-based liquid lens. By way of example, the optical reflectivity of an actuator stack including an ITO electrode disposed over PZT may be improved 300% or more by further including an ARC layer of SiO₂ over the ITO.

In addition to SiO₂, example ARC materials include AlO₃, MgF₂, ZnO, etc., which may be used individually or in multi-layer combinations. That is, plural ARC layers and/or ARC layers having a compositional gradient, e.g., formed by co-deposition, may be used to moderate the refractive index gradient of the optical element. In some embodiments, the ARC layer(s) may be patterned to provide a coating over a localized area and/or to include surface texture. In some embodiments, the actuator stack may include a conducting mesh (e.g., having a higher conductivity but lower transparency than the conductive electrodes). The ARC-containing actuator may be configured to withstand plural (e.g., >10⁶) actuation cycles and engineering strains of up to approximately 1% (e.g., approximately 0.1, 0.2, 0.5, or 1%, including ranges between any of the foregoing values).

Embodiments of the present disclosure may include or be implemented in conjunction with various types of artificial reality systems. Artificial reality is a form of reality that has been adjusted in some manner before presentation to a user, which may include, e.g., a virtual reality, an augmented reality, a mixed reality, a hybrid reality, or some combination and/or derivative thereof. Artificial-reality content may include completely generated content or generated content combined with captured (e.g., real-world) content. The artificial-reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., to perform activities in) an artificial reality.

FIG. 9 is a diagram of a head-mounted display (HMD) 900 according to some embodiments. The HMD 900 may include a lens display assembly, which may include one or more display devices. The depicted embodiment includes a left lens display assembly 910A and a right lens display assembly 910B, which are collectively referred to as lens display assembly 910. The lens display assembly 910 may be located within a transparent aperture of the HMD 900 and configured to present media to a user.

Examples of media presented by the lens display assembly 910 include one or more images, a series of images (e.g., a video), audio, or some combination thereof. In some embodiments, audio may be presented via an external device (e.g., speakers and/or headphones) that receives audio information from the lens display assembly 910, a console (not shown), or both, and presents audio data based on the audio information. The lens display assembly 910 may generally be configured to operate as an augmented reality near-eye display (NED), such that a user can see media projected by the lens display assembly 910 and also see the real-world environment through the lens display assembly 910. However, in some embodiments, the lens display assembly 910 may be modified to operate as a virtual reality NED, a mixed reality NED, or some combination thereof. Accordingly, in some embodiments, the lens display assembly 910 may augment views of a physical, real-world environment with computer-generated elements (e.g., images, video, sound, etc.).

The HMD 900 shown in FIG. 9 may include a support or frame 905 that secures the lens display assembly 910 in place on the head of a user, in embodiments in which the lens display assembly 910 includes separate left and right displays. In some embodiments, the frame 905 may be a frame of eyewear glasses. As is described herein in greater detail, the lens display assembly 910, in some examples, may include a waveguide with holographic or volumetric Bragg gratings. In some embodiments, the gratings may be generated by a process of applying one or more dopants or photosensitive media to predetermined portions of the surface of the waveguide and subsequent ultraviolet (UV) light exposure or application of other activating electromagnetic radiation.

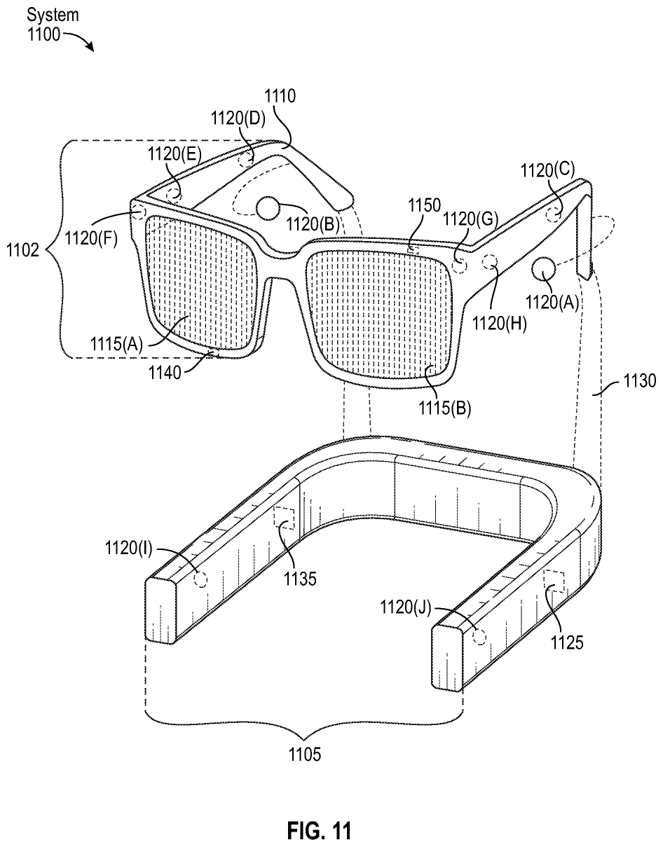

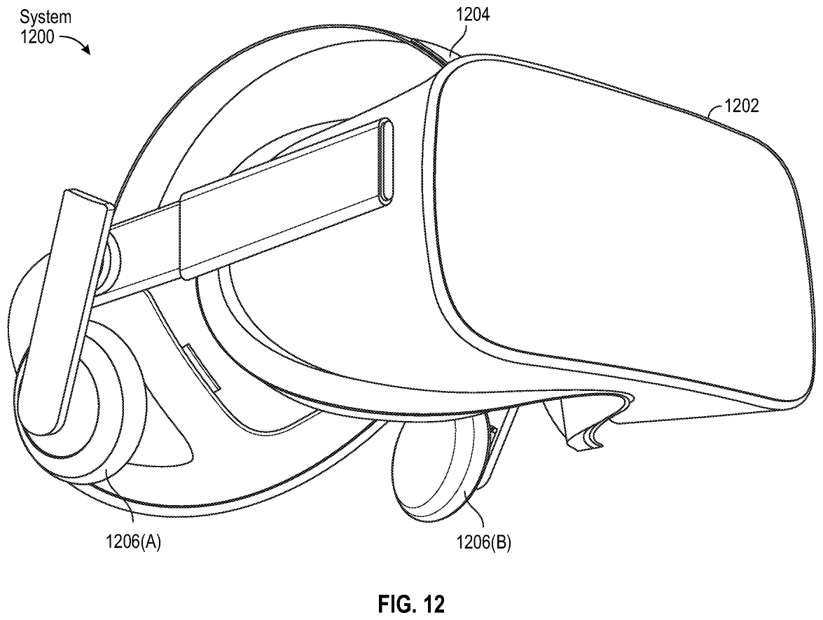

Artificial-reality systems may be implemented in a variety of different form factors and configurations. Some artificial reality systems may be designed to work without near-eye displays (NEDs), an example of which is augmented-reality system 1000 in FIG. 10. Other artificial reality systems may include a NED that also provides visibility into the real world (e.g., augmented-reality system 1100 in FIG. 11) or that visually immerses a user in an artificial reality (e.g., virtual-reality system 1200 in FIG. 12). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 generally represents a wearable device dimensioned to fit about a body part (e.g., a head) of a user. As shown in FIG. 10, system 1000 may include a frame 1002 and a camera assembly 1004 that is coupled to frame 1002 and configured to gather information about a local environment by observing the local environment. Augmented-reality system 1000 may also include one or more audio devices, such as output audio transducers 1008(A) and 1008(B) and input audio transducers 1010. Output audio transducers 1008(A) and 1008(B) may provide audio feedback and/or content to a user, and input audio transducers 1010 may capture audio in a user's environment.

As shown, augmented-reality system 1000 may not necessarily include a NED positioned in front of a user's eyes. Augmented-reality systems without NEDs may take a variety of forms, such as head bands, hats, hair bands, belts, watches, wrist bands, ankle bands, rings, neckbands, necklaces, chest bands, eyewear frames, and/or any other suitable type or form of apparatus. While augmented-reality system 1000 may not include a NED, augmented-reality system 1000 may include other types of screens or visual feedback devices (e.g., a display screen integrated into a side of frame 1002).

The embodiments discussed in this disclosure may also be implemented in augmented-reality systems that include one or more NEDs. For example, as shown in FIG. 11, augmented-reality system 1100 may include an eyewear device 1102 with a frame 1110 configured to hold a left display device 1115(A) and a right display device 1115(B) in front of a user's eyes. Display devices 1115(A) and 1115(B) may act together or independently to present an image or series of images to a user. While augmented-reality system 1100 includes two displays, embodiments of this disclosure may be implemented in augmented-reality systems with a single NED or more than two NEDs.

In some embodiments, augmented-reality system 1100 may include one or more sensors, such as sensor 1140. Sensor 1140 may generate measurement signals in response to motion of augmented-reality system 1100 and may be located on substantially any portion of frame 1110. Sensor 1140 may represent a position sensor, an inertial measurement unit (IMU), a depth camera assembly, or any combination thereof. In some embodiments, augmented-reality system 1100 may or may not include sensor 1140 or may include more than one sensor. In embodiments in which sensor 1140 includes an IMU, the IMU may generate calibration data based on measurement signals from sensor 1140. Examples of sensor 1140 may include, without limitation, accelerometers, gyroscopes, magnetometers, other suitable types of sensors that detect motion, sensors used for error correction of the IMU, or some combination thereof.

Augmented-reality system 1100 may also include a microphone array with a plurality of acoustic transducers 1120(A)-1120(J), referred to collectively as acoustic transducers 1120. Acoustic transducers 1120 may be transducers that detect air pressure variations induced by sound waves. Each acoustic transducer 1120 may be configured to detect sound and convert the detected sound into an electronic format (e.g., an analog or digital format). The microphone array in FIG. 11 may include, for example, ten acoustic transducers: 1120(A) and 1120(B), which may be designed to be placed inside a corresponding ear of the user, acoustic transducers 1120(C), 1120(D), 1120(E), 1120(F), 1120(G), and 1120(H), which may be positioned at various locations on frame 1110, and/or acoustic transducers 1120(H) and 1120(J), which may be positioned on a corresponding neckband 1105.

In some embodiments, one or more of acoustic transducers 1120(A)-(F) may be used as output transducers (e.g., speakers). For example, acoustic transducers 1120(A) and/or 1120(B) may be earbuds or any other suitable type of headphone or speaker.

The configuration of acoustic transducers 1120 of the microphone array may vary. While augmented-reality system 1100 is shown in FIG. 11 as having ten acoustic transducers 1120, the number of acoustic transducers 1120 may be greater or less than ten. In some embodiments, using higher numbers of acoustic transducers 1120 may increase the amount of audio information collected and/or the sensitivity and accuracy of the audio information. In contrast, using a lower number of acoustic transducers 1120 may decrease the computing power required by the controller 1150 to process the collected audio information. In addition, the position of each acoustic transducer 1120 of the microphone array may vary. For example, the position of an acoustic transducer 1120 may include a defined position on the user, a defined coordinate on frame 1110, an orientation associated with each acoustic transducer, or some combination thereof.

Acoustic transducers 1120 (A) and 1120 (B) may be positioned on different parts of the user's ear, such as behind the pinna or within the auricle or fossa. Or, there may be additional acoustic transducers on or surrounding the ear in addition to acoustic transducers 1120 inside the ear canal. Having an acoustic transducer positioned next to an ear canal of a user may enable the microphone array to collect information on how sounds arrive at the ear canal. By positioning at least two of acoustic transducers 1120 on either side of a user's head (e.g., as binaural microphones), augmented-reality device 1100 may simulate binaural hearing and capture a 3D stereo sound field around about a user's head. In some embodiments, acoustic transducers 1120 (A) and 1120 (B) may be connected to augmented-reality system 1100 via a wired connection 1130, and in other embodiments, acoustic transducers 1120 (A) and 1120 (B) may be connected to augmented-reality system 1100 via a wireless connection (e.g., a Bluetooth connection). In still other embodiments, acoustic transducers 1120 (A) and 1120 (B) may not be used at all in conjunction with augmented-reality system 1100.

Acoustic transducers 1120 on frame 1110 may be positioned along the length of the temples, across the bridge, above or below display devices 1115 (A) and 1115 (B), or some combination thereof. Acoustic transducers 1120 may be oriented such that the microphone array is able to detect sounds in a wide range of directions surrounding the user wearing the augmented-reality system 1100. In some embodiments, an optimization process may be performed during manufacturing of augmented-reality system 1100 to determine relative positioning of each acoustic transducer 1120 in the microphone array.

In some examples, augmented-reality system 1100 may include or be connected to an external device (e.g., a paired device), such as neckband 1105. Neckband 1105 generally represents any type or form of paired device. Thus, the following discussion of neckband 1105 may also apply to various other paired devices, such as charging cases, smart watches, smart phones, wrist bands, other wearable devices, hand-held controllers, tablet computers, laptop computers and other external compute devices, etc.

As shown, neckband 1105 may be coupled to eyewear device 1102 via one or more connectors. The connectors may be wired or wireless and may include electrical and/or non-electrical (e.g., structural) components. In some cases, eyewear device 1102 and neckband 1105 may operate independently without any wired or wireless connection between them. While FIG. 11 illustrates the components of eyewear device 1102 and neckband 1105 in example locations on eyewear device 1102 and neckband 1105, the components may be located elsewhere and/or distributed differently on eyewear device 1102 and/or neckband 1105. In some embodiments, the components of eyewear device 1102 and neckband 1105 may be located on one or more additional peripheral devices paired with eyewear device 1102, neckband 1105, or some combination thereof.

Pairing external devices, such as neckband 1105, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1100 may be provided by a paired device or shared between a paired device and an eyewear device, thus reducing the weight, heat profile, and form factor of the eyewear device overall while still retaining desired functionality. For example, neckband 1105 may allow components that would otherwise be included on an eyewear device to be included in neckband 1105 since users may tolerate a heavier weight load on their shoulders than they would tolerate on their heads. Neckband 1105 may also have a larger surface area over which to diffuse and disperse heat to the ambient environment. Thus, neckband 1105 may allow for greater battery and computation capacity than might otherwise have been possible on a stand-alone eyewear device. Since weight carried in neckband 1105 may be less invasive to a user than weight carried in eyewear device 1102, a user may tolerate wearing a lighter eyewear device and carrying or wearing the paired device for greater lengths of time than a user would tolerate wearing a heavy standalone eyewear device, thereby enabling users to more fully incorporate artificial reality environments into their day-to-day activities.

Neckband 1105 may be communicatively coupled with eyewear device 1102 and/or to other devices. These other devices may provide certain functions (e.g., tracking, localizing, depth mapping, processing, storage, etc.) to augmented-reality system 1100. In the embodiment of FIG. 11, neckband 1105 may include two acoustic transducers (e.g., 1120 (I) and 1120 (J)) that are part of the microphone array (or potentially form their own microphone subarray). Neckband 1105 may also include a controller 1125 and a power source 1135.

Acoustic transducers 1120 (I) and 1120 (J) of neckband 1105 may be configured to detect sound and convert the detected sound into an electronic format (analog or digital). In the embodiment of FIG. 11, acoustic transducers 1120 (I) and 1120 (J) may be positioned on neckband 1105, thereby increasing the distance between the neckband acoustic transducers 1120 (I) and 1120 (J) and other acoustic transducers 1120 positioned on eyewear device 1102. In some cases, increasing the distance between acoustic transducers 1120 of the microphone array may improve the accuracy of beamforming performed via the microphone array. For example, if a sound is detected by acoustic transducers 1120 (C) and 1120 (D) and the distance between acoustic transducers 1120 (C) and 1120 (D) is greater than, e.g., the distance between acoustic transducers 1120 (D) and 1120 (E), the determined source location of the detected sound may be more accurate than if the sound had been detected by acoustic transducers 1120 (D) and 1120 (E).

Controller 1125 of neckband 1105 may process information generated by the sensors on 1105 and/or augmented-reality system 1100. For example, controller 1125 may process information from the microphone array that describes sounds detected by the microphone array. For each detected sound, controller 1125 may perform a direction-of-arrival (DOA) estimation to estimate a direction from which the detected sound arrived at the microphone array. As the microphone array detects sounds, controller 1125 may populate an audio data set with the information. In embodiments in which augmented-reality system 1100 includes an inertial measurement unit, controller 1125 may compute all inertial and spatial calculations from the IMU located on eyewear device 1102. A connector may convey information between augmented-reality system 1100 and neckband 1105 and between augmented-reality system 1100 and controller 1125. The information may be in the form of optical data, electrical data, wireless data, or any other transmittable data form. Moving the processing of information generated by augmented-reality system 1100 to neckband 1105 may reduce weight and heat in eyewear device 1102, making it more comfortable to the user.

Power source 1135 in neckband 1105 may provide power to eyewear device 1102 and/or to neckband 1105. Power source 1135 may include, without limitation, lithium ion batteries, lithium-polymer batteries, primary lithium batteries, alkaline batteries, or any other form of power storage. In some cases, power source 1135 may be a wired power source. Including power source 1135 on neckband 1105 instead of on eyewear device 1102 may help better distribute the weight and heat generated by power source 1135.

As noted, some artificial reality systems may, instead of blending an artificial reality with actual reality, substantially replace one or more of a user's sensory perceptions of the real world with a virtual experience. One example of this type of system is a head-worn display system, such as virtual-reality system 1200 in FIG. 12, that mostly or completely covers a user's field of view. Virtual-reality system 1200 may include a front rigid body 1202 and a band 1204 shaped to fit around a user's head. Virtual-reality system 1200 may also include output audio transducers 1206(A) and 1206(B). Furthermore, while not shown in FIG. 12, front rigid body 1202 may include one or more electronic elements, including one or more electronic displays, one or more inertial measurement units (IMUS), one or more tracking emitters or detectors, and/or any other suitable device or system for creating an artificial reality experience.

Artificial reality systems may include a variety of types of visual feedback mechanisms. For example, display devices in augmented-reality system 1200 and/or virtual-reality system 1200 may include one or more liquid crystal displays (LCDs), light emitting diode (LED) displays, organic LED (OLED) displays, and/or any other suitable type of display screen. Artificial reality systems may include a single display screen for both eyes or may provide a display screen for each eye, which may allow for additional flexibility for varifocal adjustments or for correcting a user's refractive error. Some artificial reality systems may also include optical subsystems having one or more lenses (e.g., conventional concave or convex lenses, Fresnel lenses, adjustable liquid lenses, etc.) through which a user may view a display screen.

In addition to or instead of using display screens, some artificial reality systems may include one or more projection systems. For example, display devices in augmented-reality system 1100 and/or virtual-reality system 1200 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial reality content and the real world. Artificial reality systems may also be configured with any other suitable type or form of image projection system.

Artificial reality systems may also include various types of computer vision components and subsystems. For example, augmented-reality system 1000, augmented-reality system 1100, and/or virtual-reality system 1200 may include one or more optical sensors, such as two-dimensional (2D) or three-dimensional (3D) cameras, time-of-flight depth sensors, single-beam or sweeping laser rangefinders, 3D LiDAR sensors, and/or any other suitable type or form of optical sensor. An artificial reality system may process data from one or more of these sensors to identify a location of a user, to map the real world, to provide a user with context about real-world surroundings, and/or to perform a variety of other functions.

Artificial reality systems may also include one or more input and/or output audio transducers. In the examples shown in FIGS. 10 and 12, output audio transducers 1008(A), 1008(B), 1206(A), and 1206(B) may include voice coil speakers, ribbon speakers, electrostatic speakers, piezoelectric speakers, bone conduction transducers, cartilage conduction transducers, and/or any other suitable type or form of audio transducer. Similarly, input audio transducers 1010 may include condenser microphones, dynamic microphones, ribbon microphones, and/or any other type or form of input transducer. In some embodiments, a single transducer may be used for both audio input and audio output.

While not shown in FIGS. 10-12, artificial reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial reality devices, within other artificial reality devices, and/or in conjunction with other artificial reality devices.

By providing haptic sensations, audible content, and/or visual content, artificial reality systems may create an entire virtual experience or enhance a user's real-world experience in a variety of contexts and environments. For instance, artificial reality systems may assist or extend a user's perception, memory, or cognition within a particular environment. Some systems may enhance a user's interactions with other people in the real world or may enable more immersive interactions with other people in a virtual world. Artificial reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visuals aids, etc.). The embodiments disclosed herein may enable or enhance a user's artificial reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An anti-reflective coating comprising:
an optically transparent electrically conductive layer disposed over a substrate; and
a dielectric layer disposed over the electrically conductive layer, wherein the substrate comprises an electroactive material.

2. The anti-reflective coating of claim 1, wherein the anti-reflective coating comprises:
less than 10% haze, and
a transmissivity within the visible spectrum of at least 50%.

3. The anti-reflective coating of claim 1, wherein the anti-reflective coating comprises a reflectivity within the visible spectrum of less than 3%.

4. The anti-reflective coating of claim 1, wherein the anti-reflective coating is adapted to maintain at least 50% transmissivity over 10⁶ actuation cycles and an induced engineering strain of up to 1%.

5. The anti-reflective coating of claim 1, wherein the electrically conductive layer comprises a material selected from the group consisting of a transparent conducting oxide, graphene, nanowires, and carbon nanotubes.

6. The anti-reflective coating of claim 1, wherein a refractive index of the electrically conductive layer varies along at least one dimension of the electrically conductive layer.

7. The anti-reflective coating of claim 1, wherein the dielectric layer comprises a textured surface.

8. The anti-reflective coating of claim 1, wherein the dielectric layer comprises a material selected from the group consisting of silicon dioxide, zinc oxide, aluminum oxide, and magnesium fluoride.

9. The anti-reflective coating of claim 1, wherein the dielectric layer comprises a multi-layer stack.

10. The anti-reflective coating of claim 9, wherein the multi-layer stack comprises a layer of zinc oxide disposed directly over the electrically conductive layer and a layer of silicon dioxide disposed over the layer of zinc oxide.

11. The anti-reflective coating of claim 9, wherein the multi-layer stack comprises alternating layers of a first dielectric material and a second dielectric material.

12. The anti-reflective coating of claim 1, further comprising an electrically conductive mesh disposed adjacent to the electrically conductive layer.

13. The anti-reflective coating of claim 1, wherein a refractive index of the electrically conductive layer is less than a refractive index of the substrate and greater than a refractive index of the dielectric layer.

14. An optical element comprising:
a transparent electroactive layer;
a primary anti-reflective coating disposed over a first surface of the electroactive layer; and
a secondary anti-reflective coating disposed over a second surface of the electroactive layer opposite the first surface, wherein:
the primary anti-reflective coating comprises:
a primary conductive layer disposed directly over the first surface; and
a primary dielectric layer disposed over the primary conductive layer, and
the secondary anti-reflective coating comprises:
a secondary conductive layer disposed directly over the second surface; and
a secondary dielectric layer disposed over the secondary conductive layer.

15. The optical element of claim 14, wherein the electroactive layer comprises a piezoelectric polymer, an electrostrictive polymer, a piezoelectric ceramic, or an electrostrictive ceramic.

16. The optical element of claim 14, wherein each of the primary anti-reflective coating and the secondary anti-reflective coating is adapted to maintain at least 50% transmissivity over 10⁶ actuation cycles and an induced engineering strain of up to 1%.

17. The optical element of claim 14, further comprising a liquid lens disposed over one of the primary dielectric layer and the secondary dielectric layer.

18. A head-mounted display comprising the optical element of claim 14.

19. A method comprising:
forming an electrically conductive layer over an electroactive substrate; and
forming a dielectric layer over the electrically conductive layer to form an optical element, wherein the optical element comprises less than 10% haze and a transmissivity within the visible spectrum of at least 50%.

20. The method of claim 19, wherein the electrically conductive layer and the dielectric layer are formed simultaneously.
